(19) United States
(12) Patent Application Publication
(10) Pub. No.: US 2007/0021945 A1
(43) Pub. Date: Jan. 25, 2007

(54) Systems and methods for use in remote data collection, such as for use with atmospheric data collection devices

(76) Inventors: Frank Riskey, Boise, ID (US); Mark E. Hodges, Boise, ID (US)

Correspondence Address: PERKINS COIE LLP;PATENT-SEA, P.O. BOX 1247, SEATTLE, WA, 98111-1247, US

(21) Appl. No.: 11/325,623

(22) Filed: Jan. 3, 2006

Related U.S. Application Data
(60) Provisional application No. 60/700,976, filed on Jul. 20, 2005.
(60) Provisional application No. 60/731,920, filed on Oct. 31, 2005.

(51) Int. Cl. G06F 11/00

(52) U.S. Cl. 702/188

(57) ABSTRACT

A system for reconfiguring data collection devices located remotely from a user is described. The system enables a user to change the type of data collected by a data collection device, even after it is deployed to a remote or inaccessible environment. In some cases, the data collection devices are formed of modular components, allowing for easy implementation and configuration of the devices.

### CROSS REFERENCE(S) TO RELATED APPLICATIONS

This application claims priority to commonly-owned U.S. Provisional Patent Application No. 60/700,976, filed Jul. 20, 2005, and commonly-owned U.S. Provisional Patent Application 60/731,920, filed Oct. 31, 2005, which are incorporated by reference in their entirety.

### STATEMENT REGARDING FEDERALLY SPONSORED RESEARCH

This invention was made with government support under contract number NNJO4JA27C awarded by the National Aeronautics and Space Administration. The government may have certain rights in the invention.

### TECHNICAL FIELD

The described technology is directed to the field of data collection, e.g., the field of environmental data collection.

### BACKGROUND

Tracking and monitoring information associated with individuals, systems, and/or environments of interest can be important in almost any context, including commercial contexts (e.g., mobile business applications, asset management, product development and testing, field service management, etc.), scientific contexts (e.g., health care, environmental research, animal research, space exploration, etc.), and other contexts (e.g., sports, recreation, military/defense, etc.). Recent advancements in technology have resulted in tracking and monitoring devices that can reliably be placed in uncontrolled environments for significant periods of time. For example, such devices may be used to track migratory and home range movements of animals and monitor environmental factors (e.g., location, temperature, motion, battery level, heart rate, noise, reactions, and so on). They can also be used to track the status of a vehicle (e.g., aircraft or spacecraft). In another example, monitoring devices may be placed inside an animal (or human) to monitor physiological conditions.

In some cases, such devices (sometimes falling into the category of telemetry devices) may be configured to transmit collected information to one or more data collection systems located apart from the individual, system, or environment of interest. In this way, the collected information can ultimately be accessed for human consumption or, for example, as input for a computerized process. This is especially useful in the case where it may be difficult (or impossible) to retrieve the device once it has been placed within the individual, system, or environment of interest (e.g., in the case of space exploration). However, in current systems, devices are often pre-configured before deployed into a remote environment. Users, therefore, are limited to data captured by the device based on the configuration of the device at the time of deployment. Should a user wish to capture other types of data, however, the user would have to deploy additional devices or retrieve the existing device from remote locations often difficult to get to, which can make for an expensive and time-consuming task.

### BRIEF DESCRIPTION OF THE DRAWINGS

FIG. 1 is a block diagram showing an example of system components in some embodiments.

FIG. 2 is a block diagram showing a more detailed view of the receiving device of FIG. 1 in some embodiments.

FIG. 3 is a block diagram showing a more detailed view of the data collection device of FIG. 1 in some embodiments.

FIG. 4 is a flow diagram showing an example of an operational routine used by the facility for reconfiguring sensor parameters and capturing information for the user.

FIG. 5 is an example of a display provided by the facility to allow a user to reconfigure sensor parameters.

FIG. 6A is a flow diagram showing an example of an operational routine used by the system for reconfiguring sensor parameters at a data collection device.

FIG. 6B is a block diagram of certain components of a data collection device in some embodiments.

FIG. 7 is a block diagram showing an exploded view of a modular data collection device in some embodiments.

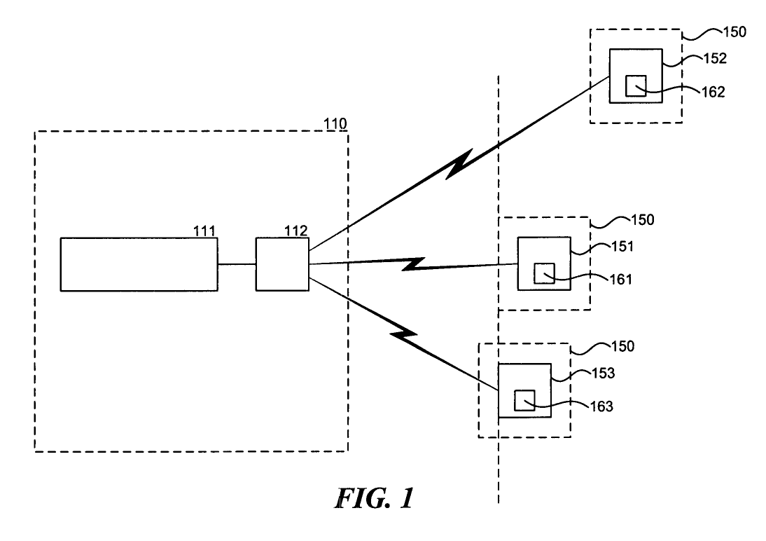

In the drawings, the same reference numbers identify identical or substantially similar elements or acts. To facilitate the discussion of any particular element or act, the most significant digit or digits in a reference number refer to the figure number in which that element is first introduced (e.g., element 112 is first introduced and discussed with respect to FIG. 1).

A portion of this disclosure contains material to which a claim for copyright is made. The copyright owner has no objection to the facsimile reproduction by anyone of the patent document or patent disclosure (including Figures), as it appears in the Patent and Trademark Office patent file or records, but reserves all other copyright rights whatsoever.

### DETAILED DESCRIPTION

Aspects of the invention will now be described with respect to various embodiments. The following description provides specific details for a thorough understanding of, and enabling description for, these embodiments. However, one skilled in the art will understand that aspects of the invention may be practiced without these details. In other instances, well-known structures and functions have not been shown or described in detail to avoid unnecessarily obscuring the description of the embodiments described herein.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A dynamic facility (or system) of data collection devices used for the collection of data in remote or somewhat inaccessible environments is described herein. The system may include reconfigurable data collection devices located remotely from a user. The system may also include data collection devices that can be easily modified to meet particular needs of users. In some cases, the data collection devices are modular devices that allow for the addition or removal of sensor components to provide flexibility in the type of data to be captured (e.g., atmospheric data such as temperature, motion, noise, location, and so on). In some cases, the data collection devices are integrated devices that are fixed to one or more sensing applications and manufactured with fixed components in order to tailor the device to certain applications (e.g. a motion detector comprising a few components to make it small and lightweight). The system, therefore, is a dynamically reconfigurable and adaptable system of data collection devices that can be easily modified to meet the needs of a user at any time.

For example, the system may provide access to configuration settings and parameters of a data collection device situated in a remote location. In this example, the system may employ one or more communication links (e.g., a radio frequency link) to provide two-way communication between a receiving subsystem (to which a user may have access) and a remotely located data collection device. While in communication with the data collection device, the data collection system may enable the user, at the receiving subsystem, to reconfigure the data capture settings and parameters of the data collection device. In some cases, these settings and parameters relate to the type of data being captured and/or to how frequently the data is captured. The system, therefore, may allow users to modify data collection device capabilities to provide flexibility with regard to using the devices with unforeseen applications, in unknown environments, or when specifically needed (in order to preserve battery life, for example).

In some embodiments, the system may employ modular data collection devices. These devices are designed to accommodate the addition (or removal) of sensor and other components into the data collection device, providing even greater flexibility in capturing various types of data. A manufacturer of the system, therefore, may design data collection devices in a modular capacity to quickly build and/or reconfigure data collection devices meeting specific needs of customers. For example, a controller board, a sensor component, and a communication component may each be manufactured separately and put together to form the data collection device. In addition to the sensor components, the modular devices may also be reconfigurable with respect to other components, such as communication components, attaching components, and so on, allowing for greater flexibility in quickly providing and reconfiguring devices for customers.

II. Sample System Architecture

FIG. 1 and the following discussion provide a brief, general description of a suitable environment in which the system can be implemented. Although not required, aspects of the system are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like.

Aspects of the system can be embodied in a special purpose computer or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communication network. In a distributed computing environment, program modules may be located in both local and remote memory storage devices.

Aspects of the system may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as a mobile device.

Aspects of the system can also be practiced in distributed computing environments where certain tasks or modules are performed by remote processing devices and which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described herein may be stored or distributed on computer-readable media, including magnetic and optically readable and removable computer disks, hard-wired or preprogrammed in chips (e.g., EEPROM semiconductor chips), as well as distributed electronically over the Internet or over other networks (including wireless networks). Those skilled in the relevant art will recognize that portions of the invention reside on a server computer, while corresponding portions reside on a client computer. Data structures and transmission of data particular to aspects of the invention are also encompassed within the scope of the invention. In general, while hardware platforms, such as a personal computer and remote computer, are described herein, aspects of the invention are equally applicable to nodes on a network having corresponding resource locators to identify such nodes.

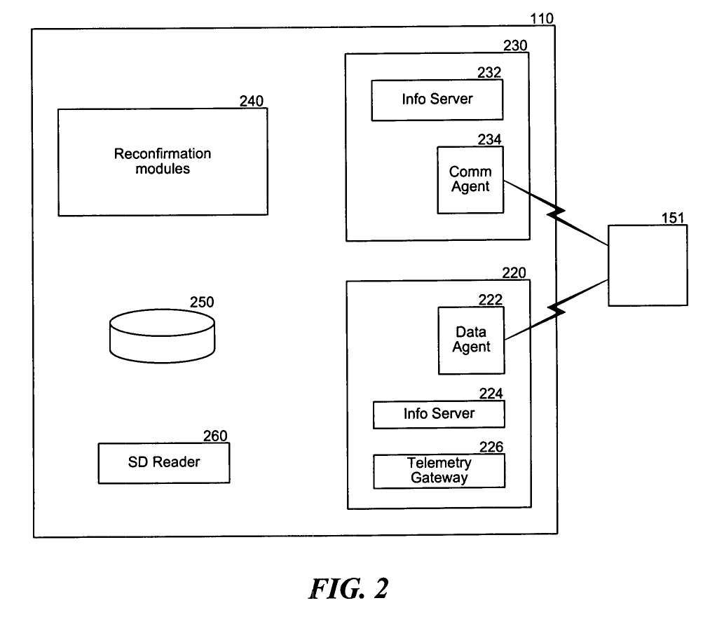

Referring to FIG. 1, the system comprises a receiving device 110 which may include a computing device 111 and communication link device 112, and one or more data collection devices 151, 152, and 153 situated in a location (or locations) 150 remote from the receiving device 110. For example, data collection devices could be in the wild or other inaccessible locations (e.g., in space, underwater, and so on), on or inside an animal or human, attached to a vehicle, and so on. In some embodiments, the computing device 111 is responsible for the retrieval and storage of data collected by the data collection devices 151, 152, and 153. Data collected by devices 151, 152, and 153 could be, for example, location data (such as global positioning data), temperature data (such as the temperature of an animal or location), other atmospheric data, motion data (such as the magnitude and direction of acceleration of a bobsled), physiological data (of a subject) and so on. Additionally, the computing device 111 may be responsible for the translation and presentation of data to a user. Additional discussion of the receiving device 110 is discussed with regard to FIG. 2.

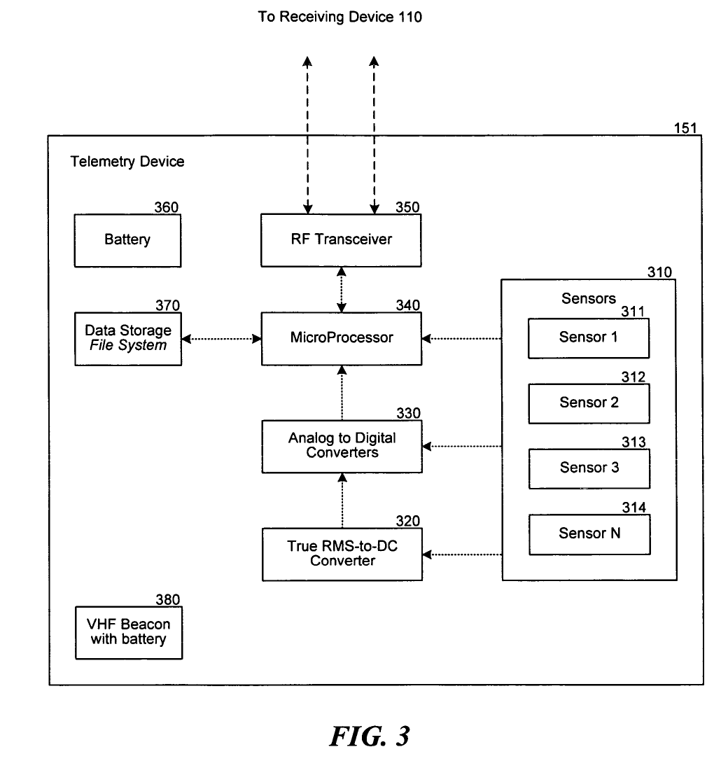

In some embodiments the data collection devices 151, 152, and 153 employ sensor components 161, 162, and 163, respectively, to capture data (such as environmental data) from various environments. Examples of sensor components 161, 162 and 163 include temperature sensors, noise sensors, location sensors, motion sensors, physiological sensors and so on. Further details regarding the functionality of the data collection devices are discussed with respect to FIG. 3.

Referring to FIG. 2, in some embodiments, the receiving device 110 comprises functional modules (e.g., some implemented as software) such as a translation module 220, a communication module 230, and a reconfiguration module 240. The receiving device may also comprise components such as databases 250 and SD memory Card Readers 260 to facilitate the storage and translation of received reconfiguration information. The translation module 220 may comprise subcomponents such as data agents 222, an information server 224, and a telemetry gateway 226. The system uses the translation module 220 to retrieve incoming data from data collection devices and translate the data into human-readable data streams or a common data format, which can then be presented to users. Additional details regarding the retrieval and translation of data can be found in commonly-owned U.S. patent application Ser. No. ______, entitled “MANAGING INFORMATION COLLECTED IN REAL-TIME OR NEAR REAL-TIME, SUCH AS SENSOR INFORMATION USED IN THE TESTING AND MEASUREMENT OF ENVIRONMENTS AND SYSTEMS,” (attorney docket No. 571788001US1), filed concurrently herewith.

In some embodiments, the system uses the communication module 230 to communicate with the data collection devices 151, 152, and 153. The communication module 230 may comprise subcomponents such as an information server 232 and a communication agent 234. For example, the information server 234 may convert user-entered configuration settings received by the reconfiguration module 240 to information streams that can then be communicated to the data collection devices 151, 152, and 153 through an RF transceiver acting as the communication agent 234.

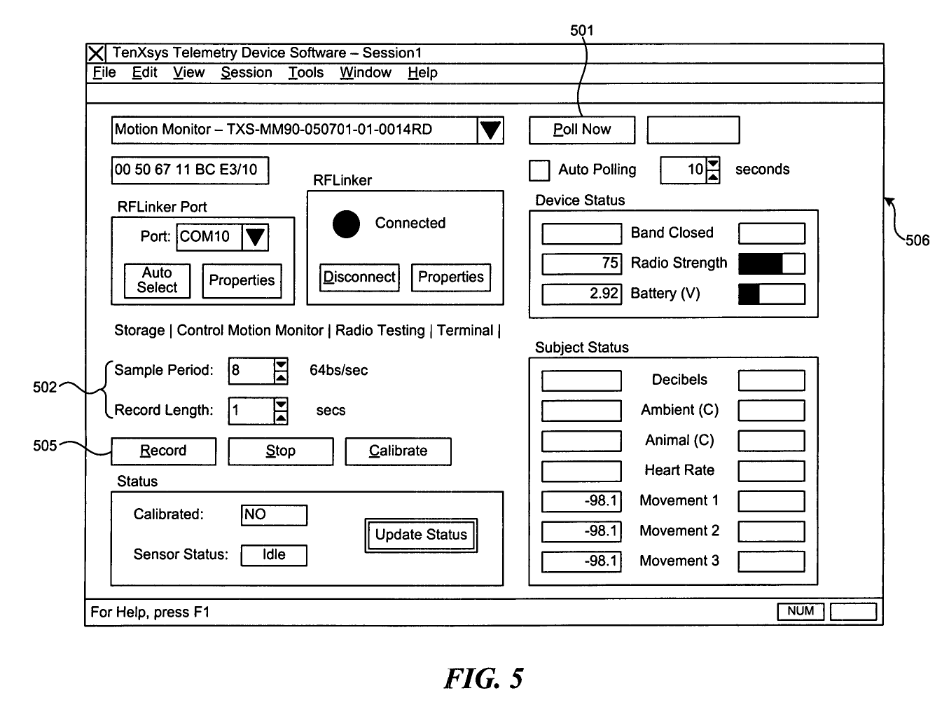

In some embodiments, the reconfiguration module 240 is responsible for presenting configuration settings and parameters associated with one or more of the data collection devices 151, 152, and 153 to a user. The reconfiguration module 240 is also responsible for receiving reconfiguration information from a user to alter the configuration settings and parameters of the devices 151, 152 and, 153. The reconfiguration module 240 may be implemented as a combination of hardware and software and presented to the user as a user interface, such as the display/user interface depicted in FIG. 5. Types of configuration settings and parameters to be altered may include the number of data recordings per cycle, the length of a recording cycle, the type of data to be recorded, the time frame in which to transmit recorded data, and so on.

FIG. 3 is a more detailed view of one of the data collection devices 151 from FIG. 1. In some embodiments, data collection device 151 is responsible for the capture of data from a location remote from a user (e.g., data collection device 151 is placed on a satellite in space), such as a location that would be difficult to get to by a human or would be generally inaccessible to a user while the device is situated with a subject (such as on a moving bobsled). A sensor module 310 associated with the data collection device 151 may comprise one or more sensor components 311-314, which may differ in use and application (e.g., GPS sensor, an accelerometer, and a gyroscope may each be implemented into data collection device 151). The data collection device 151 may further comprise data conversion components 320 and 330 (such as true RMS-to-DC and analog to digital converters) that convert some or all of the data captured by the sensor components 311-314 into digital data streams to be sent to a microprocessor 340. A transceiver 350, such as an RF transceiver, is responsible for transmitting the data streams to the receiving device 110 via a communication link such as an RF communication link. The transceiver 350 also is responsible for communicating with each of the sensors.

The microprocessor 340 may contain a reconfiguration device (such as a microcontroller) 341 and semipermanent memory component 342 (such as flash ROM, PROM or EPROM) which may contain firmware 343 used to implement the settings and parameters associated with the sensor components 311-314.

Additionally, the data collection device 151 may comprise a power source 360 (such as a battery, a kinetic energy scavenging system, and so on) to provide power to the data collection device 151, a data storage module 370 to store captured data, and a VHF Beacon 380 to transmit (and receive) communication to (and from) the receiving device 110. The power source may also be configured to recharge while the data collection device is remotely located from the user.

One skilled in the art will realize that the system is not limited by data collection devices and configuration possibilities discussed above. For example, the system may use many different types of data collection devices, motion detection devices, motion capture devices, motion monitor devices, temperature measurement devices, audio capture devices, video capture devices, location determining devices, other environmental data collection devices, physiologic devices (such as heart rate sensors, blood oximetry sensors, blood pressure sensors) and so on.

III. Reconfiguration Example

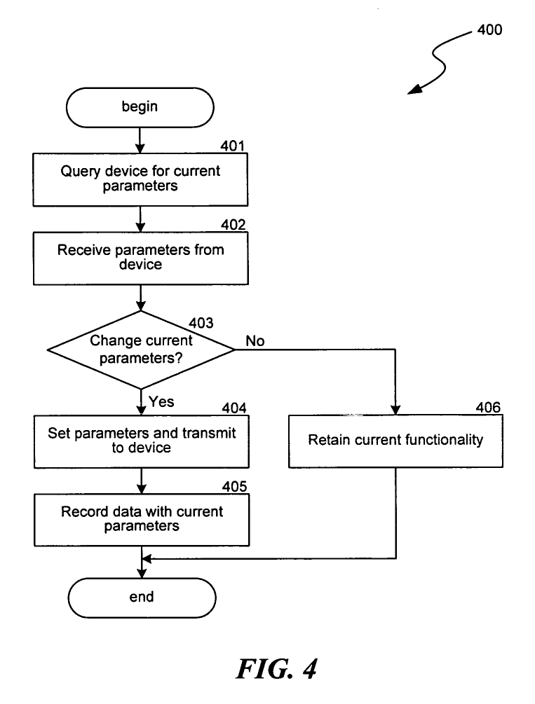

FIG. 4 is a flow diagram showing an example of an operational routine used by the system for reconfiguring sensor parameters and capturing information for the user The routine may be performed at a receiving device associated with the system, such as the receiving device 110 of FIG. 1. This flow diagram (and other flow diagrams discussed below) does not show all functions or exchanges of data but, instead, provides an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTP, and so on.

The routine of FIG. 4 is discussed in association with a user interface 500 for controlling configuration of data collection device 151, as shown in FIG. 5. At block 401, (e.g., in response to a user clicking a “Poll Now” button 501 shown in FIG. 5) the routine queries a data collection device 151 for current (or previously implemented) configuration parameters associated with a specified sensor component 161 of the data collection device 151. For example, if the data collection device 151 is a motion monitoring device containing, among other components, a sensor component (such as an accelerometer), the routine may cause a 900 MHz radio transceiver located within a receiving device 110 to transmit a query signal to the data collection device 151 which then receives the query via a comparable 900 MHz radio transceiver. At block 402, the routine polls for and receives current parameters from the data collection device 151 via a similar signal. For example, the routine may poll sensor component 161 of the data collection device 151 for current parameters (a first data capture setting) associated with data capture and determine that the sensor component 161 is configured to measure acceleration data at a specified sample period (e.g., ⅛^{th} (8/64) of a second for a total time of one second). The routine then causes this polled information to be transmitted back to the receiving device 110 (e.g., so it can be displayed in a display component 502 within the user interface 500). At decision block 403, if the routine is prompted (e.g., via user input) to change current parameters, the routine continues at block 404, else the routine continues at block 406 and ends. At block 404, if the user decides to reconfigure one or more parameters (to a second data capture setting) of the sensor component, the routine transmits user-provided reconfiguration information (e.g., received via display component 502, FIG. 5) to the data collection device 151. For example, the system may receive user input via component 502 to change the “record length” of the accelerometer component from one to two seconds. The system may then transmit the new record length setting for the accelerometer component to the data collection device 151. Upon receiving the new settings at the data collection device, the system reconfigures the accelerometer parameter of record length with the accelerometer component. In response to a user clicking a “record” button 505, at block 405, the system uses the accelerometer component of data collection device 151 to capture data motion data given the reconfigured parameters (e.g., a second data capture setting), and ends.

User interface 500, as discussed in the previous example, may provide a user with a variety of user input and device status components, such as components 501, 502 and 505 described above. Examples of other components, shown in FIG. 5, may include a device selection component, network and/or device connection components, status components (such as the device's or a subject's status), and so on. These components may allow a user to update a device, to receive practical information regarding a device (such as the battery life) or a subject (such as the current temperature) of the device, to initiate automatic functions, to calibrate one or more functions of a device, and so on. As such, the system is not limited to the exemplary components depicted in FIG. 5.

Although the above example relates to the reconfiguration of settings and parameters before the recording of data by a sensor component within a data collection device, one skilled in the art will appreciate that the system may also reconfigure of settings and parameters during the real-time capture of data by sensor components. For example, if a data collection device containing a temperature sensor component is measuring the temperature of a remote location (such as measuring the temperature at the top of a mountain), the system may be transmitting temperature recordings once every 60 seconds for a length of 24 hours. After deploying the data collection device, a user of the system may be informed that there are specific time frames within the 24 hours when it would be advantageous to have a higher frequency of temperature recordings. While it reads temperature, the system may allow a user to reconfigure the record period to switch from once every 60 seconds to once every 10 seconds. In this example, the system enables a user to reconfigure settings and parameters without having to stop the collection of data.

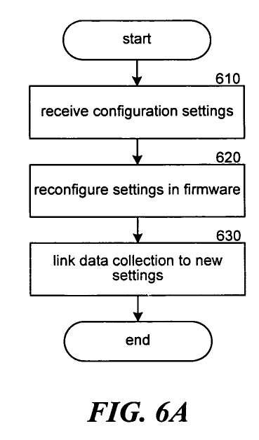

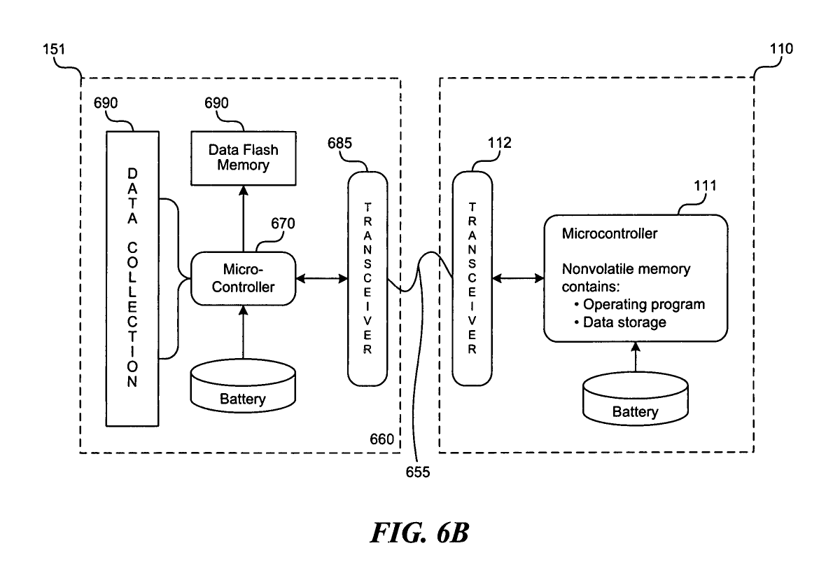

FIG. 6A is a flow diagram showing an example of an operational routine used by the system for reconfiguring sensor parameters at the data collection device. The routine of FIG. 4 is discussed in association with a block diagram 650 of certain components of data collection device 151, as shown in FIG. 6B.

At block 610 (at transceiver 660), the routine receives configuration settings (implemented by a user at receiving device 110) via a communication link 655 (such as a radio link) from communication device 112 at receiving device 110, and continues to block 620. At block 620, the routine receives the settings from the transceiver 660 and updates firmware 685 (using microcontroller 670) located in memory 680 with the newly received settings, and continues to block 630. One skilled in the art will appreciate that the reconfiguration of settings stored in firmware 685 may be performed using any known techniques. At block 630, the routine links the sensor components 690 used to collect data with the settings in firmware 685 and ends.

IV. Examples of Data Collection Devices Used in the System

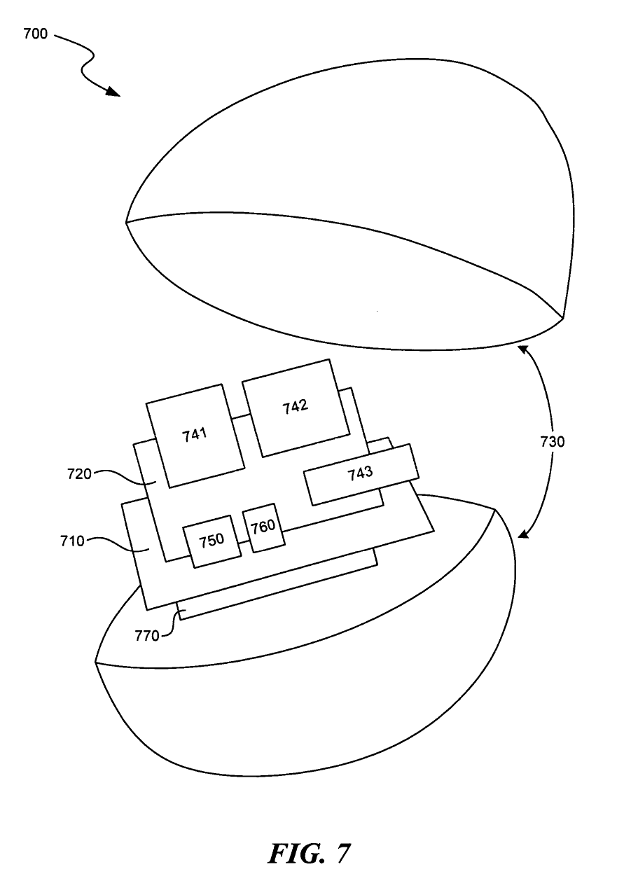

As discussed earlier, in some embodiments, the data collection devices are manufactured with modular components, as is shown in FIG. 7. A data collection device 700, for example, may comprise a main controller board 710, a communication board 720, a housing 730, and one or more sensor components 741, 742, and 743 either integrated into the main controller board or placed on individual controller boards specific for the sensor component. Other components may include a battery 750 (or power source), a VHF Beacon 760 (or other antenna), other printed circuit assemblies 770 (PCAs), mechanisms used to secure the data collection device to a subject being monitored (such as a collar and quick release mechanism that attached a data collection device to an animal), and so on.

The main controller board 710 may comprise a microprocessor, analog to digital converters, a true RMS-to-DC converter, a data storage component, flash memory or other memory components (such as semipermanent memory components), and other components used to control the device or convert, store and process data captured by sensor components.

The communication board 720 may comprise a two-way Radio transmitter (able to communicate at radio frequencies such as 900 MHz or 2.4 GHz), a two-way paging transceiver, a wireless network transceiver (able to communicate under the IEEE 802.11x protocols), and/or satellite communication transmitters (such as those developed by Argos and ORBCOMM), operating, for example, on the Ku Band.

In some embodiments, the housing 730 of a data collection device is tailored to the subject and environment. Examples include an animal pack (a case enclosing the data collection device is attached to an animal via a harness having a release mechanism), a nest monitor (may be egg shaped to blend into the environment, with the data collection device contained within the egg shaped housing), a neoprene sleeve (and other forms enabling a data collection device to conform to a human, such as a wristband) or other suitable housings enabling the data collection device to observe the natural habits of subjects or environments being monitored (such as a lightweight housing for motion detection, a housing adapted to make contact with a subject, and so on).

Virtually any type of sensor component 741, 742 and 743 may be implemented into the data collection devices. Examples include motion detectors (such as 3-axis accelerometers), ambient temperature sensors (and other thermal sensors), skin temperature sensors, audio sensors (such as heart rate sensors), blood pressure sensors, location sensors (such as GPS sensors), light sensors, vibration sensors, chemical sensors, odor sensors, radiation sensors, hydration sensors, glucose sensors, ECG sensors, respiration rate sensors, pulse oximeter sensors and so on. In addition, the data collection devices, in some embodiments, may be used with or configured to accommodate third party sensor components.

In some cases, where certain factors (such as size or weight) determine the design of the data collection device, it may be advantageous to provide integrated data collection devices within the system. Unlike modular devices, integrated devices comprise one controller board receiving many, if not all, of the components. For example, some data collection devices used to monitor motion (such as a device having an accelerometer and GPS sensor) are designed to be as small and lightweight as possible (e.g., they are attached to a bird and used to capture data pertaining to the bird's acceleration while flying). In this example, having the various components on one controller board allows for the data collection device to be smaller and lighter.

### CONCLUSION

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the facility is not intended to be exhaustive or to limit the invention to the precise form disclosed above. While specific embodiments of, and examples for, the facility are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments.

This application is related to commonly-owned U.S. patent application Ser. No. ______, filed Jan. 3, 2006, entitled MANAGING INFORMATION COLLECTED IN REAL-TIME OR NEAR REAL-TIME, SUCH AS SENSOR INFORMATION USED IN THE TESTING AND MEASUREMENT OF ENVIRONMENTS AND SYSTEMS (Attorney Docket No. 571788001US1). All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the reconfiguration system and data collection devices may vary considerably in their implementation details, while still be encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A system for capturing data at a location generally inconvenient and remote to a user, the system comprising:
a data collection subsystem situated at the location, the data collection subsystem comprising:
a data collection component having multiple sensor components, each of the sensor components configured to collect environmental data related to the location; and
a reconfiguration device adapted to adjust settings associated with the environmental data collection by the multiple sensor components; and
a data receiving subsystem, the data receiving subsystem comprising:
a communication subsystem for providing wireless two-way communication between the data receiving subsystem and the data collection subsystem;
a data retrieval subsystem for retrieving data collected at the inaccessible location;
a data store subsystem for storing the retrieved data;
a translation subsystem for translating the stored data retrieved into a common data format;
a presentation subsystem for presenting the translated data to the user; and
a reconfiguration module adapted to receive reconfiguration information from the user related to the settings associated with the environmental data collected by the multiple sensor components at the location and to provide the reconfiguration information to the communication subsystem for transmittal to the data collection subsystem; and
wherein the reconfiguration device of the data collection subsystem is configured to receive the reconfiguration information and adjust the settings associated with the environmental data collection based on the received reconfiguration information.

2. The system of claim 1, the reconfiguration device comprising a controller component used to control the data collection device, wherein the controller component comprises a memory and a microcontroller adapted to reconfigure firmware embedded in the memory upon receiving the reconfiguration information, and wherein further the firmware contains the settings associated with the environmental data collection.

3. The system of claim 1, wherein the data collection subsystem further comprises:
a housing; and
a communication component adapted to be in wireless two-way communication with the communication subsystem;
wherein the housing, communication component and data collection component are separate components from the controller component.

4. The system of claim 1, wherein the communication subsystem comprises a radio frequency transceiver operating at a frequency of 900 MHz or 2.4 GHz.

5. The system of claim 1, wherein the reconfiguration module comprises software presented to the user as a user interface.

6. The system of claim 1, wherein the settings associated with environmental data collected by the data collection device relate to type of data, frequency of collection, or duration of collection.

7. The system of claim 1, wherein each of the multiple sensor components is a motion sensor, a location sensor, a temperature sensor, or a noise sensor.

8. A method of collecting environmental data at a data collection device placed in a location generally inaccessible to a user, the data collection device having at least one sensor component, the method comprising the steps of:
capturing environmental data with the at least one sensor component using a first data capture setting;
while capturing environmental data using a first data capture setting, receiving a second data capture setting derived from reconfiguration information provided by the user; wherein the second data capture setting is different from the first data capture setting;
reconfiguring the data collection device to the second data capture setting; and
capturing environmental data with the sensor component using the second data capture setting.

9. The method of claim 8, wherein the first and second data capture settings relate to type of data, frequency of collection, or duration of collection.

10. The method of claim 8, wherein the at least one sensor component is a motion sensor, a location sensor, a temperature sensor, or a noise sensor.

11. The method of claim 8, wherein the data collection device is a modular device comprising the following separate components:
a housing;
one or more sensor components;
a communication component adapted to provide wireless two-way communication between the data collection device and a user; and
a controller component used to control the data collection device, wherein the controller component comprises a memory and a microcontroller adapted to reconfigure firmware embedded in the memory upon receiving reconfiguration information, and wherein further the firmware contains the settings associated with the environmental data collection.

12. The method of claim 8, wherein the data collection device is communicatively linked to a reconfiguration module located in proximity to the user, wherein the reconfiguration module is adapted to receive the reconfiguration information provided by the user, the reconfiguration information related to the second data capture setting.

13. The method of claim 8, wherein the receiving a second data capture setting occurs during real time capture of data by the data collection device using the first data capture setting.

14. A data collection device used to collect environmental data in an generally inaccessible location remote from a user, comprising:
a housing,
multiple sensor components;
a two-way radio frequency transceiver; and
a controller board used to control the data collection device and interact with the multiple sensor components and the wireless two-way radio frequency transceiver, wherein the controller component comprises a memory and a microcontroller adapted to adjust firmware embedded in the memory while the data collection device is within the generally inaccessible location;
wherein the each of the multiple sensor components and the two-way radio frequency transceiver are not located on the controller board, and wherein further the sensor components, the two-way radio frequency transceiver, and the controller board are located within the housing.

15. The data collection device of claim 14, further comprising:
a battery used to provide power to the data collection device;
an antenna used to receive radio frequency communications from the user; and
a data storage facility used to store data collected by the plurality of sensor components.

16. The data collection device of claim 14, further comprising a wireless two-way satellite communication transceiver.

17. The data collection device of claim 14, wherein the two-way radio frequency transceiver is adapted to receive communications at a frequency of 900 MHz or 2.4 GHz.

18. The data collection device of claim 14, wherein the housing of the data collection device is adapted to attach to an animal or a human.

19. The data collection device of claim 14, wherein the housing of the data collection device is adapted to blend into the environment.

20. A system for collecting environmental data at a data collection device placed in a location generally inaccessible to a user, the data collection device having at least one sensor component, the method comprising the steps of:
means for capturing environmental data with the at least one sensor component using a first data capture setting;
means for receiving a second data capture setting derived from reconfiguration information provided by the user; wherein the second data capture setting is different from the first data capture setting;
means for reconfiguring the data collection device to the second data capture setting while capturing environmental data using the first data capture setting; and
means for capturing environmental data with the sensor component using the second data capture setting.

21. The system of claim 20, further comprising:
means for communicatively linking the data collection device to a means for reconfiguring the data collection device located in proximity to the user, wherein means for reconfiguring the data collection device is adapted to receive reconfiguration information provided by the user, the reconfiguration information related to data capture settings.
